(19) United States
(12) Patent Application Publication
(10) Pub. No.: US 2024/0404761 A1
(43) Pub. Date: Dec. 5, 2024

(54) Solid Electrolytic Capacitor and Method for Producing Solid Electrolytic Capacitor

(71) Applicant: KYOCERA AVX Components Corporation, Fountain Inn, SC (US)

(72) Inventor: Nagai Toshiyuki, Kyoto (JP)

(21) Appl. No.: 18/262,751

(22) PCT Filed: Jun. 1, 2022
(86) PCT No.: PCT/JP2022/022274

§ 371 Date: Jul. 25, 2023

(30) Foreign Application Priority Data
Jun. 8, 2021 (JP) 2021-096145

(51) Int. Cl. H01G 9/00; H01G 9/028; H01G 9/052; H01G 9/10; H01G 9/15

(52) U.S. Cl. CPC H01G 9/0003; H01G 9/0029; H01G 9/028; H01G 9/052; H01G 9/10; H01G 9/15

(57) ABSTRACT

The present invention provides: a solid electrolytic capacitor which is capable of suppressing damage on a solid electrolyte layer and a method for producing a solid electrolytic capacitor. This solid electrolytic capacitor is provided with: a porous sintered body 1 which has a first surface 11, while containing a valve-acting metal; a positive electrode wire 10 which protrudes from the first surface 11, while containing a valve-acting metal; a dielectric layer 2 which is formed on the porous sintered body 1; a solid electrolyte layer 3 which is formed on the dielectric layer 2; and a negative electrode layer 4 which is formed on the solid electrolyte layer 3. The solid electrolyte layer 3 comprises a first layer 31 which is formed on the dielectric layer 2 and a second layer 32 which is formed on the first layer 31; and this solid electrolyte capacitor comprises a protective layer 5 which covers at least a part of the first surface 11, with the first layer 31 being interposed therebetween.

### TECHNICAL FIELD

The present invention relates to a solid electrolytic capacitor and a method for manufacturing a solid electrolytic capacitor.

### BACKGROUND TECHNOLOGY

Patent Literature 1 discloses an example of a conventional solid electrolytic capacitor. The solid electrolytic capacitors disclosed in the literature comprise a porous sintered body, a dielectric layer, a solid electrolyte layer, a cathode layer, an anode terminal, a cathode terminal, and a sealing resin protruding from the anode wire. The porous sintered body and the anode wire are made of a valvular metal such as Ta (tantalum) or Nb (niobium). The solid electrolyte layer consists of a conductive polymer.

### CITATION LIST

### Patent Literature

Patent Literature 1: Japanese Unexamined Patent Application Publication No. 2017-168621

### SUMMARY OF THE INVENTION

### Problems to be Solved by the Invention

The solid electrolyte layer may be damaged during the step of bonding the anode wire to the anode terminal or during use.

The present invention is conceived in the context of the above-described circumstances, and the challenge is to provide a solid electrolytic capacitor and a method for manufacturing a solid electrolytic capacitor that can suppress damage to the solid electrolyte layer.

### Means for Solving the Problems

The solid electrolytic capacitor comprises a porous sintered body 1 having a first surface and comprising a valve metal, an anode wire protruding from the first surface and comprising a valve metal, a dielectric layer formed on the porous sintered body; a solid electrolyte layer formed on the dielectric layer, and a cathode layer formed on the solid electrolyte layer; the solid electrolyte layer comprising a first layer formed on the dielectric layer, and a second layer formed on the first layer, and a protective layer covering at least a portion of the first surface with the first layer interposed therebetween.

A method of manufacturing a solid electrolytic capacitor provided by a second side of the present invention comprises forming a porous sintered body having a first surface protruding by an anode wire comprising a valve metal and comprising a valve metal; forming a dielectric layer on the porous sintered body; forming a solid electrolyte layer on the dielectric layer; and forming a cathode layer on the solid electrolyte layer comprising forming a first layer on the dielectric layer; and forming a second layer on the first layer; and forming a protective layer overlying at least a portion of the first surface after forming the first layer.

### Effects of Invention

According to the present disclosure, damage to the solid electrolyte layer can be suppressed.

Other features and advantages of the present invention will become more apparent by the detailed description given below with reference to the accompanying drawings.

### BRIEF DESCRIPTION OF THE DRAWING

FIG. 1 is a cross-sectional view illustrating a solid electrolytic capacitor according to a first embodiment of the present disclosure.

FIG. 2 is an enlarged cross-sectional view of a key portion illustrating a solid electrolytic capacitor according to a first embodiment of the present disclosure.

FIG. 3 is a flow diagram illustrating a method of manufacturing a solid electrolytic capacitor according to a first embodiment of the present disclosure.

FIG. 4 is a cross-sectional view illustrating a method of manufacturing a solid electrolytic capacitor according to a first embodiment of the present disclosure.

FIG. 5 is a cross-sectional view illustrating a method of manufacturing a solid electrolytic capacitor according to a first embodiment of the present disclosure.

FIG. 6 is a cross-sectional view illustrating a method of manufacturing a solid electrolytic capacitor according to a first embodiment of the present disclosure.

FIG. 7 is a cross-sectional view illustrating a method of manufacturing a solid electrolytic capacitor according to a first embodiment of the present disclosure.

FIG. 8 is a cross-sectional view illustrating a method of manufacturing a solid electrolytic capacitor according to a first embodiment of the present disclosure.

FIG. 9 is a cross-sectional view illustrating a method of manufacturing a solid electrolytic capacitor according to a first embodiment of the present disclosure.

FIG. 10 is a cross-sectional view illustrating a method of manufacturing a solid electrolytic capacitor according to a first embodiment of the present disclosure.

FIG. 11 is a cross-sectional view illustrating a solid electrolytic capacitor according to a second embodiment of the present disclosure.

FIG. 12 is a flow diagram illustrating a method of manufacturing a solid electrolytic capacitor according to a second embodiment of the present disclosure.

FIG. 13 is a cross-sectional view illustrating a method of manufacturing a solid electrolytic capacitor according to a second embodiment of the present disclosure.

FIG. 14 is a cross-sectional view illustrating a solid electrolytic capacitor according to a third embodiment of the present disclosure.

FIG. 15 is a flow diagram illustrating a method of manufacturing a solid electrolytic capacitor according to a third embodiment of the present disclosure.

FIG. 16 is a cross-sectional view illustrating a method of manufacturing a solid electrolytic capacitor according to a third embodiment of the present disclosure.

FIG. 17 is a cross-sectional view showing a solid electrolytic capacitor according to a fourth embodiment of the present disclosure.

FIG. 18 is an enlarged cross-sectional view of a key portion illustrating a solid electrolytic capacitor according to a fourth embodiment of the present disclosure.

FIG. 19 is a flow diagram illustrating a method of manufacturing a solid electrolytic capacitor according to a fourth embodiment of the present disclosure.

FIG. 20 is a cross-sectional view illustrating a method of manufacturing a solid electrolytic capacitor according to a fourth embodiment of the present disclosure.

### MODES FOR CARRYING OUT THE INVENTION

Preferred embodiments of the present disclosure will be specifically described below with reference to the drawings.

In the present disclosure, A is formed on B includes where A is in direct contact with B and where A is provided in a position overlying B via other objects.

The terms “first”, “second”, “third”, etc. in this disclosure are used for identification purposes only and are not intended to impose a permutation on the objects.

### First Embodiment

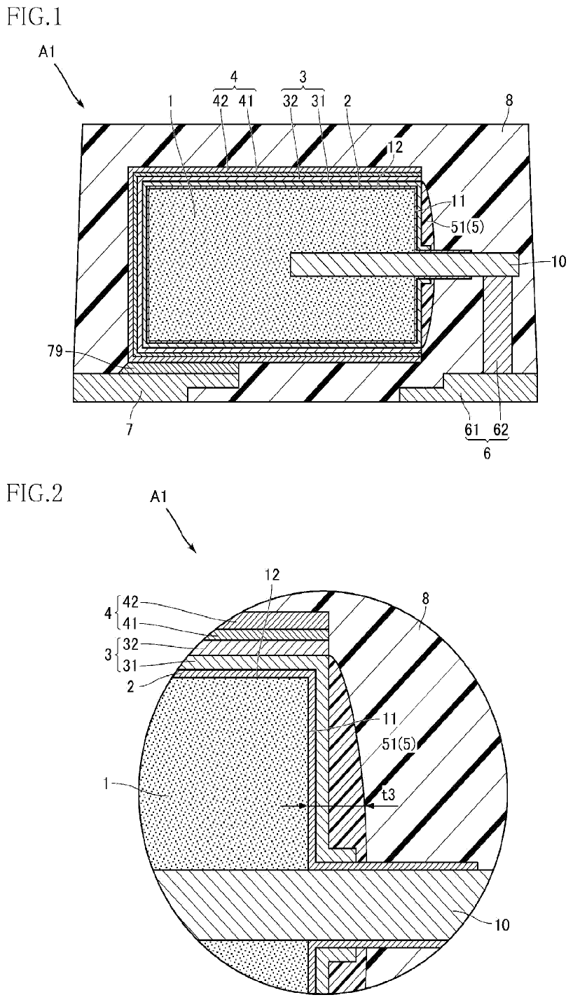

FIGS. 1 and 2 illustrate a solid electrolytic capacitor according to a first embodiment of the present disclosure. The solid electrolytic capacitor A1 of this embodiment comprises a porous sintered body 1, an anode wire 10, a dielectric layer 2, a solid electrolyte layer 3, a cathode layer 4, a protective layer 5, an anode conduction member 6, a cathode conduction member 7, and a sealing resin 8.

The porous sintered body 1 contains a valve metal and is formed, for example, by sintering an intermediate product obtained by compressing fine powder of the valve metal, and has a large number of pores inside. The valve metal contained in the porous sintered body 1 includes, for example, Ta (tantalum) or Nb (niobium). The porous sintered body 1 of this embodiment has a first surface 11 and a second surface 12. When the shape of the porous sintered body 1 is a rectangular parallelepiped, the first surface 11 is one surface forming the rectangular parallelepiped, and the second surfaces 12 are four surfaces connected to the first surface 11. Alternatively, when the porous sintered body 1 has a columnar shape, the first surface 11 is one end surface and the second surface 12 is a peripheral side surface connected to the first surface 11.

The anode wire 10 protrudes from the first surface 11 of the porous sintered body 1, and a portion of which enters the porous sintered body 1. The anode wire 10 includes a valve metal. The valve metal contained in the porous sintered body 1 includes, for example, Ta (tantalum) or Nb (niobium). The valve metal included in the anode wire 10 is preferably the same as the valve metal included in the porous sintered body 1.

The dielectric layer 2 is formed on the porous sintered body 1. The dielectric layer 2 is directly in contact with the porous sintered body 1. Also, in the present embodiment, the dielectric layer 2 is formed on a portion of the anode wire 10 and directly contacts a portion of the anode wire 10. The dielectric layer 2 covers the outer surface including first surface 11 and second surface 12 of porous sintered body 1 and pores within the porous sintered body 1. The dielectric layer 2 comprises, for example, an oxide of a valve metal, including Ta₂O₅ (tantalum pentoxide), Nb₂O₅ (niobium pentoxide), and the like.

The solid electrolyte layer 3 is formed on dielectric layer 2. The solid electrolyte layer 3 is directly in contact with the dielectric layer 2. The solid electrolyte layer 3 includes a first layer 31 and a second layer 32. The first layer 31 is formed on the dielectric layer 2 and is directly in contact with the dielectric layer 2. The second layer 32 is formed on the first layer 31 and directly contacts the first layer 31. The first layer 31 includes portions formed on the first surface 11 and on the second surface 12 via the dielectric layer 2. Also, in the illustrated example, the first layer 31 includes a portion formed over a portion of the anode wire 10 via the dielectric layer 2. The second layer 32 includes a portion formed on the second surface 12 via the dielectric layer 2 and the first layer 31 and is provided in a location away from the first surface 11. The first layer 31 and the second layer 32 include, for example, a conductive polymer. Specific examples of conductive polymers include, for example, polypyrroles, polythiophenes, polyanilines, polyfurans, and the like.

The cathode layer 4 is formed on the solid electrolyte layer 3. The cathode layer 4 is directly in contact with the second layer 32 of the solid electrolyte layer 3. The cathode layer 4 of the present embodiment is formed on the solid electrolyte layer 3 and is directly in contact with the second layer 32. The graphite layer 41 contains graphite. The metal layer 42 is formed on the graphite layer 41 and is in direct contact with graphite layer 41. The metal layer 42 includes, for example, Ag (silver). The cathode layer 4 of the present embodiment is formed on the outer surface of the porous sintered body 1, including the second surface 12, and is provided in a location away from the first surface 11.

The protective layer 5 covers at least a portion of the first surface 11 via the dielectric layer 2 and the first layer 31. The protective layer 5 comprises an insulative material. Insulative materials included in the protective layer 5 include, for example, fluoropolymers, silicone resins, acrylic resins, and the like. Preferred examples of insulating materials include PVF (Polyvinyl Fluoride), ETFE (Ethylene Tetrafluoroethylene), FEP (Fluorinated Ethylene Propylene), PFA (copolymer of tetrafluoroethylene and perfluoroalkoxyethylene), PTEF (polytetrafluoroethylene), fluoroolefin-vinyl ether copolymer (FEVE: Fluorethylene Vinyl Ether), a mixture of polyvinylidene fluoride and acrylic resin (PVDF: Poly Vinylidene Di Fluoride), and the like. The protective layer 5 of this embodiment is directly in contact with the first layer 31.

The protective layer 5 of this embodiment has a first part 51. Part 151 covers almost the entire surface of surface 11. The first part 51 is also provided in a position that avoids the second side 12. The second layer 32 is formed in a position that avoids the protective layer 5 (first part 51). The protective layer 5 (first part 51) covers a portion of the anode wire 10 via both the dielectric layer 2 and the solid electrolyte layer 3 or only the dielectric layer 2. In the present embodiment, the thickness t3 to the surface of the protective layer 5 (first part 51) on the first surface 11 is so thick that it is closer to the anode wire 10. The thickness t3 corresponds to a third thickness of the present disclosure.

The anode conduction member 6 is a member that conducts the porous sintered body 1 and the anode wire 10 and the circuit (illustrated) in which the solid electrolytic capacitor A1 is mounted. The specific configuration of the anode conduction member 6 is not limited in any way, and in the present embodiment includes a terminal portion 61 and a relay portion 62.

The terminal portion 61 has an exposed portion from the sealing resin 8 and is used as a mounting terminal when a solid electrolytic capacitor A1 is mounted. The terminal portion 61 includes a metal, such as copper (Cu). Also, the mounting surface of terminal portion 61 may be provided with a plating layer (illustrated) such as tin (Sn) and nickel (Ni).

The relay portion 62 relays the anode wire 10 and the terminal portion 61 and is bonded to both the anode wire 10 and the terminal portion 61. The relay portion 62 includes a metal, such as copper (Cu). The method of bonding the relay portion 62 to the anode wire 10 and the terminal part 61 is not limited in any way. The relay portion 62 and anode wire 10 are joined, for example, using laser welding. The terminal portion 61 and relay portion 62 are joined by welding, for example, laser welding, resistance welding, etc., or by bonding methods using conductive bonding materials.

The cathode conduction member 7 is a member that conducts the cathode layer 4 and the circuit (illustrated) on which the solid electrolytic capacitor A1 is mounted. The specific configuration of the cathode conduction member 7 is not limited in any way, and in the present embodiment it consists of a plate-like member. The cathode conduction member 7 includes a metal, such as copper (Cu). Also, the mounting surface of the cathode conduction member 7 may be provided with a plating layer (illustrated) such as tin (Sn) and nickel (Ni). The cathode conduction member 7 is electrically bonded to the cathode layer 4 via the conductive bonding material 79. The conductive bonding material 79 contains, for example, silver (Ag).

The sealing resin 8 includes the porous sintered body 1, the anode wire 10, the dielectric layer 2, the solid electrolyte layer 3, the cathode layer 4, the protective layer 5, and the anode conduction member 6 and the cathode conduction member 7, respectively. The sealing resin 8 includes, for example, an epoxy resin. The anode conduction member 6 and the cathode conduction member 7 are each partially exposed from the sealing resin 8.

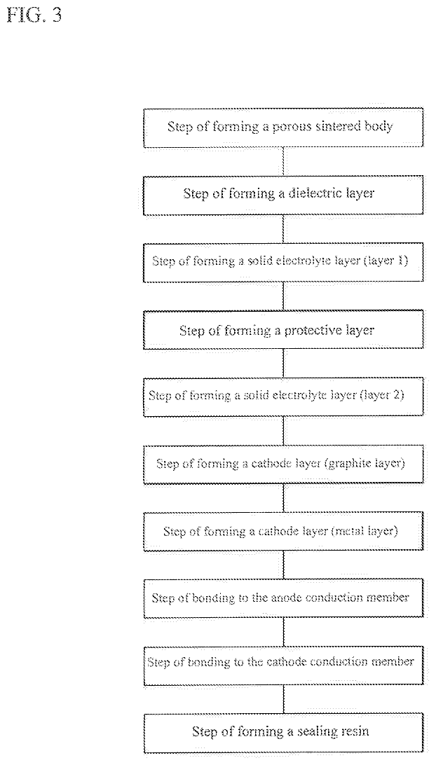

The method of making solid electrolytic capacitor A1 is then described below with reference to FIGS. 3-10.

As shown in FIG. 3, a method of manufacturing a solid electrolytic capacitor A1 includes forming a porous sintered body 1, forming a dielectric layer 2, forming a solid electrolyte layer 3 (first layer 31), forming a protective layer 5, forming a solid electrolyte layer 3 (second layer 32), forming a cathode layer 4 (graphite layer 41), forming a cathode layer 4 (metal layer 42), bonding to an anodic conduction member 6, bonding to a cathode conduction member 7, and forming a sealing resin 8. In the present embodiment, after the step of forming the first layer 31, the step of forming the protective layer 5 is performed prior to the step of forming the second layer 32.

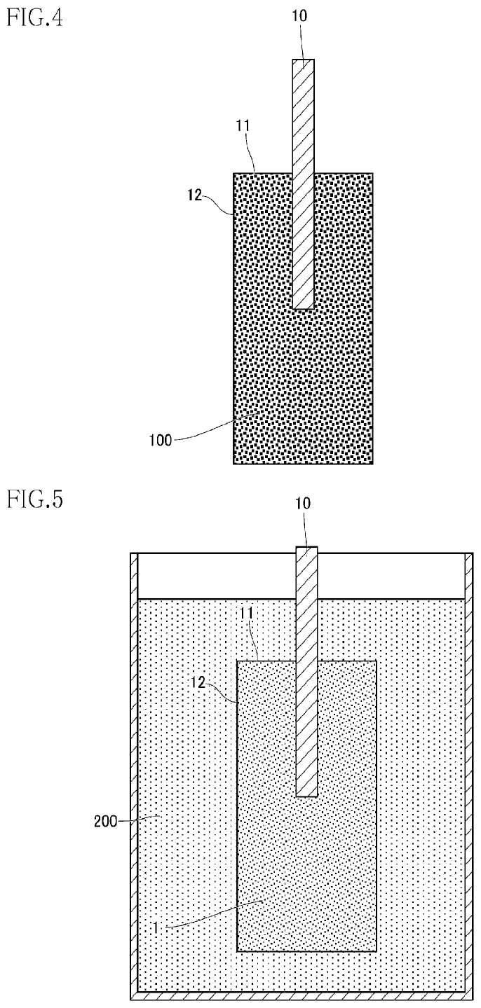

First, as shown in FIG. 4, an intermediate 100 is formed. The formation of the intermediate 100 is accomplished by pressurizing a fine powder of a valve metal, such as Ta (tantalum) or Nb (niobium). This pressurization is done with the anode wire 10 inserted into the fine powder of the valve metal. This results in an intermediate 100 with the anode wire 10 protruding from the first surface 11. The intermediate 100 is then sintered. This results in a porous sintered body 1.

The dielectric layer 2 is then formed. The formation of the dielectric layer 2 is accomplished by anodizing the porous sintered body 1 and a portion of the anode wire 10 with the chemical conversion solution 200 soaked, for example, as shown in FIG. 5. As the chemical conversion solution 200, for example, an aqueous solution of phosphoric acid may be used. This results in a dielectric layer 2 covering the outer surface of the porous sintered body 1 and the pores and a portion of the anode wire 10.

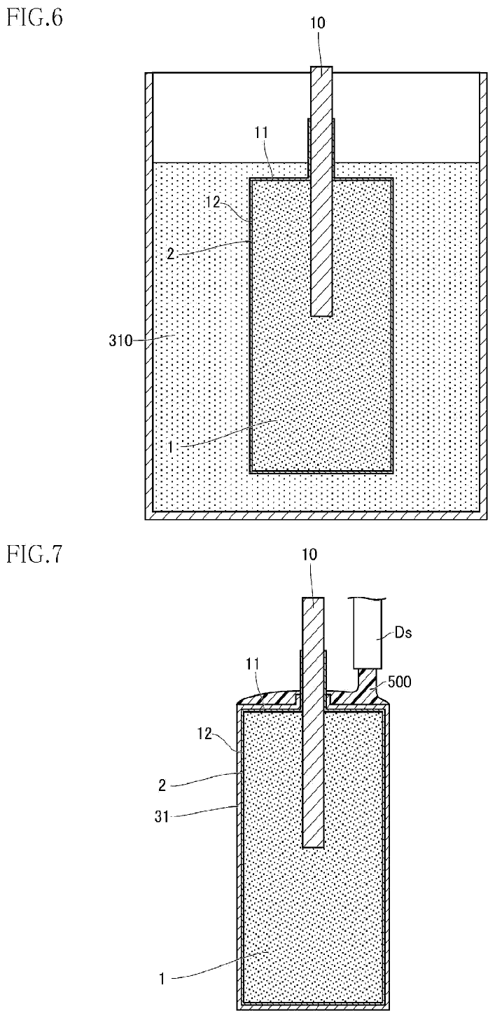

The first layer 31 is then formed. Formation of the first layer 31 is accomplished by chemical or electrolytic polymerization treatment on the porous sintered body 1 to which the dielectric layer 2 is formed, for example, as shown in FIG. 6. In these polymerization processes, for example, the porous sintered body 1 formed with dielectric layer 2 is immersed in a reaction solution 310 comprising a monomer. In the present embodiment, the porous sintered body 1 and a portion of the anode wire 10 are immersed in the reaction solution 310. However, the portion of the anode wire 10 exposed from the dielectric layer 2 is not immersed in the reaction solution 310. The polymerization treatment forms a first layer 31. The first layer 31 is formed over a surface of the porous sintered body 1 including first surface 11 and second surface 12 and a portion of the anode wire 10. The first layer 31 is laminated onto the dielectric layer 2. It should be noted that after forming the first layer 31, a chemical conversion treatment may be performed again.

The protective layer 5 is then formed. The formation of the protective layer 5 is accomplished by applying a resin paste 500 with dispenser Ds, for example, as shown in FIG. 7. Dispenser Ds is a device capable of applying a certain amount of resin paste 500. The resin paste 500 is a material for configuring an insulating material included in the protective layer 5. In the present embodiment, the resin paste 500 is applied by dispenser Ds to cover first surface 11. At this time, the resin paste 500 is not applied on the second surface 12. The resin paste 500 also covers a portion of the anode wire 10 via dielectric layer 2 and first layer 31. By applying a predetermined treatment such as drying, heating, ultraviolet irradiation, etc., to the resin paste 500, a protective layer 5 is obtained.

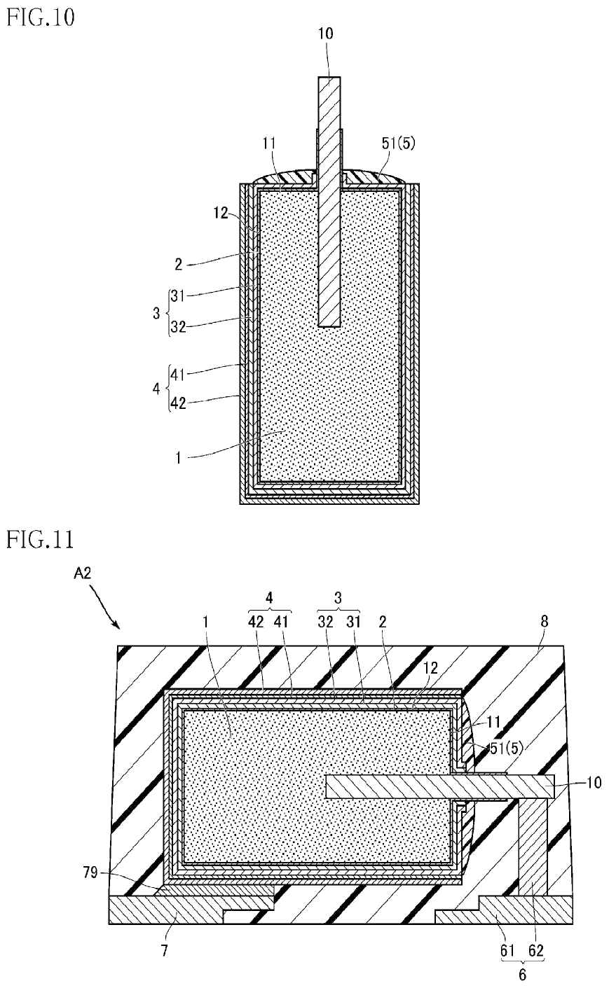

The second layer 32 is then formed. The formation of the second layer 32 is carried out by chemical or electrolytic polymerization treatment on the porous sintered body t to which the dielectric layer 2, the first layer 31 and the protective layer 5 are formed, for example, as shown in FIG. 7. In these polymerization processes, for example, the porous sintered body 1 formed with the dielectric layer 2, the first layer 31 and the protective layer 5 is immersed in a reaction solution 320 comprising a monomer. In the present embodiment, the protective layer 5 (first surface 11) is not immersed in the reaction solution 320. The polymerization treatment forms a second layer 32, as shown in FIG. 9. The second layer 32 is formed on the outer surface of the porous sintered body 1 except the first surface 11 and is directly in contact with the first layer 31. It should be noted that after forming the second layer 32, a chemical conversion treatment may be performed again.

The graphite layer 41 is then formed and the metal layer 42 is formed, as shown in FIG. 10. This results in a cathode layer 4 consisting of a graphite layer 41 and a metal layer 42. The cathode layer 4 is formed on the outer surface except the first surface 11 of the porous sintered body 1 and directly contacts the second layer 32 of the solid electrolyte layer 3.

Thereafter, the anode conduction member 6 is bonded to the anode wire 10 and the cathode conduction member 7 is bonded to the metal layer 42 of the cathode layer 4. The porous sintered body 1 and anode wire 10, in which the dielectric layer 2, the solid electrolyte layer 3, the cathode layer 4 and the protective layer 5 are formed, form a sealing resin 8 that covers a portion of anode conduction member 6 and cathode conduction member 7, respectively. This results in the solid electrolytic capacitor A1 described above.

Next, the operation of the solid electrolytic capacitor A1 and the method for manufacturing the solid electrolytic capacitor A1 will be described.

As shown in FIGS. 1 and 2, a first layer 31 is formed on the first surface 11 of the porous sintered body 1. In the manufacturing method of the solid electrolytic capacitor A1, a load may be applied to the root of the anode wire 10, for example, during laser welding to bond the anode wire 10 to the relay portion 62 or during use of the solid electrolytic capacitor A1. It is a concern that this load will damage the first layer 31. According to this embodiment, the first layer 31 is covered by a protective layer 5 (first part 51) on the first surface 11. Thus, according to this embodiment, damage of the solid electrolyte layer 3 can be suppressed.

The first part 51 is formed on the entire surface of the first surface 11. This can more reliably protect the first layer 31 on the first surface 11.

As shown in FIG. 2, the thickness 13 to the surface of the protective layer 5 (first part 51) on the first surface 11 is so thick that it is closer to the anode wire 10. This allows for more secure protection of the first layer 31 at a location close to the anode wire 10 when a load is generated at the root of the anode wire 10.

The use of the fluororesin illustrated above as the protective layer 5 is preferred in that it can be easily dispersed into a solvent in the manufacturing process and exhibits high weather resistance. As for the fluoropolymer included in the protective layer 5, the glass transition temperature is 150° C. or less, preferably 120° C. or less, and more preferably 100° C. or less.

As shown in FIG. 7, in the present embodiment, a protective layer 5 is formed by applying a resin paste 500 with dispenser Ds. This allows the resin paste 500 to be applied more accurately in the area of wear.

FIGS. 11-20 illustrate other embodiments of the present invention. In these figures, elements identical or similar to the above embodiments are marked with the same sign as the above embodiments.

### Second Embodiment

FIG. 11 illustrates a solid electrolytic capacitor according to a second embodiment of the present disclosure. The solid electrolytic capacitor A2 of this embodiment is formed with a protective layer 5 on the second layer 32.

In this embodiment, the second layer 32 has a portion formed on the first surface 11. The portion is directly in contact with the first layer 31. The first part 51 of the protective layer 5 is directly in contact with the second layer 32.

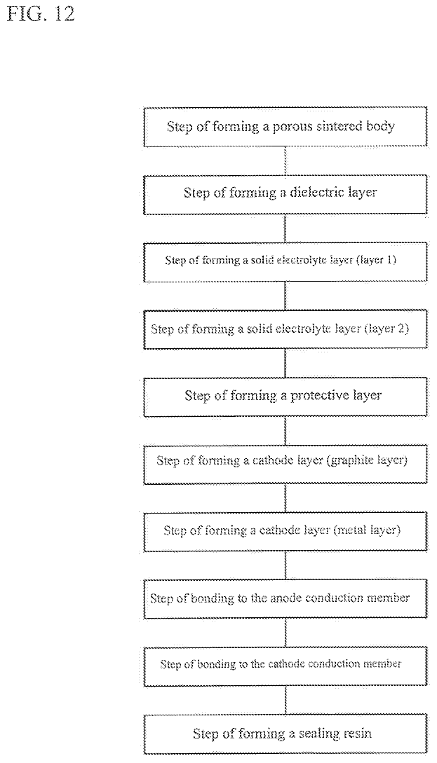

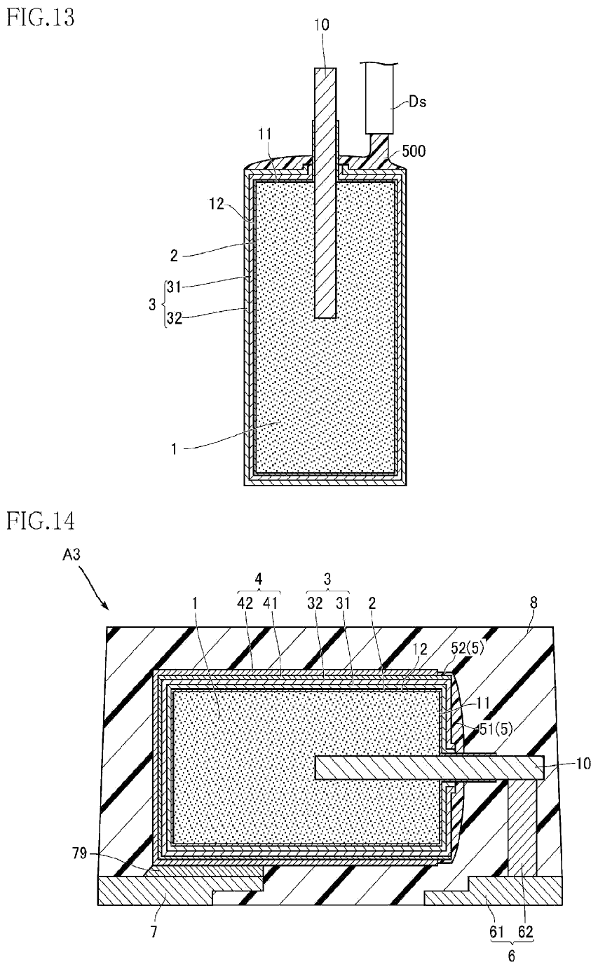

FIGS. 12 and 13 illustrate a method of manufacturing a solid electrolytic capacitor A2. As shown in FIG. 12, in the present embodiment, after the step of forming the second layer 32, the step of forming the protective layer 5 is performed prior to the step of forming the graphite layer 41.

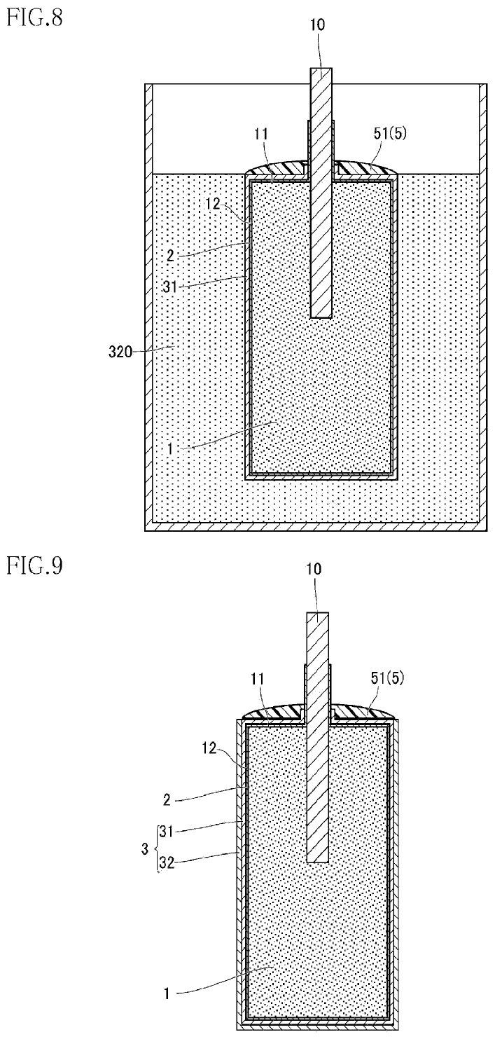

As shown in FIG. 13, after forming the second layer 32, the first surface 11 of the porous sintered body 1 is covered by the dielectric layer 2, the first layer 31 and the second layer 32. That is, in the chemical or electrolytic polymerization process shown with reference to FIG. 8, a portion of the first surface 11 and the anode wire 10 is immersed in the reaction solution 320. Then, in the process shown in FIG. 13, the resin paste 500 is applied to the second layer 32 formed on the first surface 1l using dispenser Ds.

This embodiment can also inhibit damage to the solid electrolyte layer 3. According to this embodiment, the first layer 31 and the second layer 32 can also be protected by a protective layer 5 (first part 51) on the first surface 11.

### Third Embodiment

FIG. 14 illustrates a solid electrolytic capacitor according to a third embodiment of the present disclosure. The protective layer 5 is formed on the graphite layer 41 in the solid electrolytic capacitor a3 of the present embodiment.

In the present embodiment, the protective layer 5 has a first part 51 and a second part 52. The first part 51 is formed on the first surface 11. The dielectric layer 2, the first layer 31 and the second layer 32 are interposed between the first part 51 and the first surface 11. The first part 51 is directly in contact with the second layer 32.

The second part 52 is formed on the second surface 12. In the present embodiment, between the second part 52 and the second surface 12, the dielectric layer 2, the first layer 31, the second layer 32, and the graphite layer 41 are interposed. The second part 52 is directly in contact with the graphite layer 41. The uncovered portion of the graphite layer 41 in the second portion 52 is covered by the metal layer 42. A portion of the second part 52 may be covered by a metal layer 42.

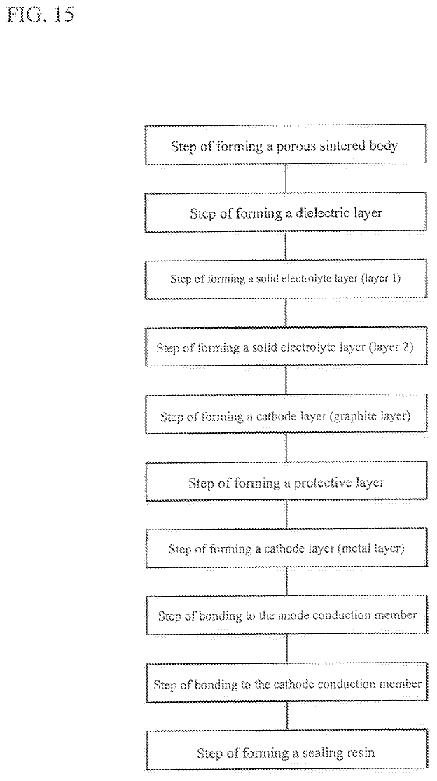

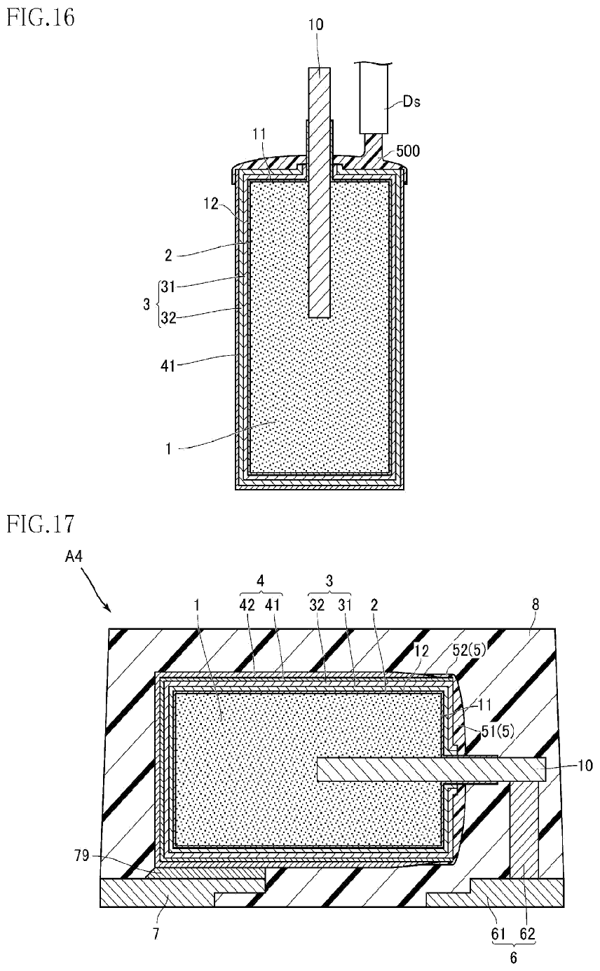

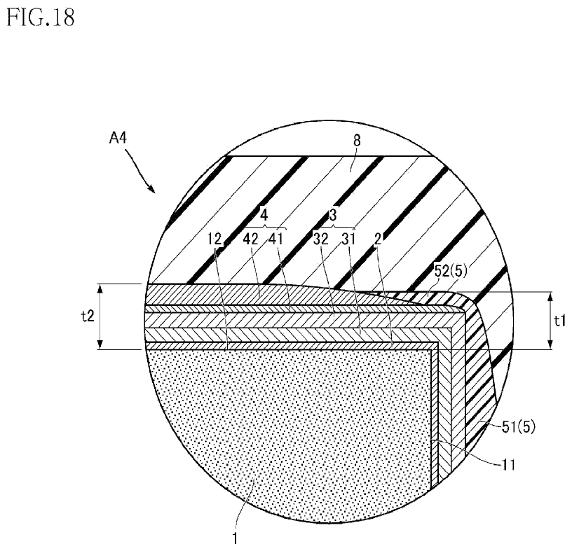

FIGS. 15 and 16 illustrate a method of manufacturing a solid electrolytic capacitor A3. As shown in FIG. 15, in the present embodiment, after the step of forming the graphite layer 41, the step of forming the protective layer 5 is performed prior to the step of forming the metal layer 42.

In this embodiment, the resin paste 500 is applied using dispenser Ds after forming the graphite layer 41, as shown in FIG. 16. In the illustrated example, the resin paste 500 is applied over substantially the entire surface of the first surface 11 and over a portion of the second surface 12. The resin paste 500 applied on the first surface 1 contacts the second layer 32. The resin paste 500 applied on the second surface 12 contacts the graphite layer 41.

The application of the resin paste 500 on the second surface 12 may be intentional or may be the result of a portion of the resin paste 500 extending over the second surface 12 to more reliably apply the entire surface on the first surface 11. Thus, the boundary between the first surface 11 and the second surface 12 is not limited to a configuration covered by a resin paste 500 (protection layer 5) over the entire length. Only a portion of the boundary may be configured to be covered by a resin paste 500 (protection layer 5).

This embodiment can also inhibit damage to the solid electrolyte layer 3. Also according to this embodiment, a portion of graphite layer 41 is covered by the protective layer 5 (the second part 52). As a result, it is possible to prevent the graphite layer 41 from being peeled off or cracked from the end portion thereof.

### Fourth Embodiment

FIGS. 17 and 18 illustrate a solid electrolytic capacitor according to a fourth embodiment of the present disclosure. The solid electrolytic capacitor A4 of this embodiment has a protective layer 5 formed on the metal layer 42.

In the present embodiment, the protective layer 5 has a first part 51 and a second part 52. The first part 51 is formed on the first surface 11. The dielectric layer 2, the first layer 31 and the second layer 32 are interposed between the first part 51 and the first surface 11. The first part 51 is directly in contact with the second layer 32.

The second part 52 is formed on the second surface 12. In the present embodiment, between the second part 52 and the second surface 12, the dielectric layer 2, the first layer 31, the second layer 32, the graphite layer 41 and the metal layer 42 are interposed. The second part 52 has a portion directly in contact with the graphite layer 41 and a portion directly in contact with the metal layer 42. The uncovered portion of the graphite layer 41 in the second portion 52 is covered by the metal layer 42.

As shown in FIG. 18, in the illustrated example, the maximum thickness t1 from the second surface 12 to the surface of the part 52 (protection layer 5), is thinner than the thickness t2, which is the maximum thickness of the layer 42 to the surface. The thickness t1 corresponds to the first thickness of the present disclosure. The thickness t2 corresponds to the second thickness of the present disclosure.

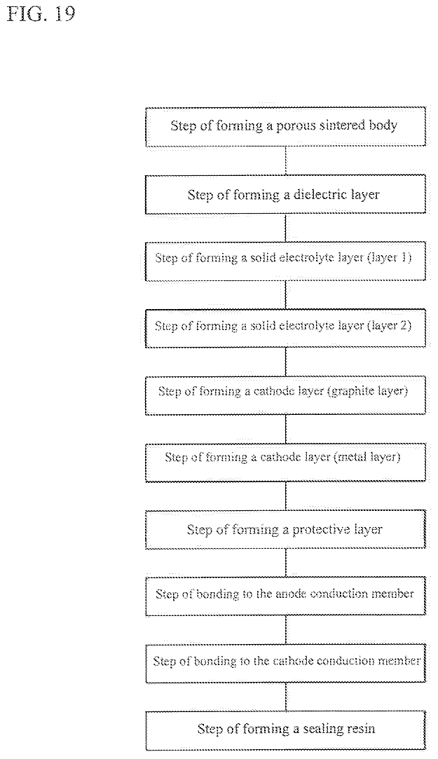

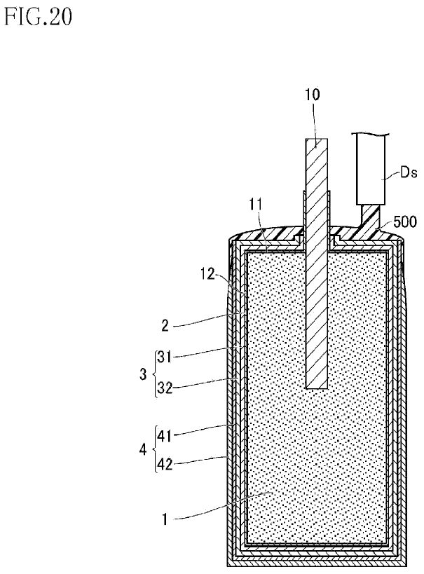

FIGS. 19 and 20 illustrate a method of manufacturing a solid electrolytic capacitor A3. As shown in FIG. 19, in the present embodiment, the step of forming a protective layer 5 is performed after the step of forming a metal layer 42.

In this embodiment, the resin paste 500 is applied using dispenser Ds after forming the graphite layer 442, as shown in FIG. 20. In the illustrated example, the resin paste 500 is applied over substantially the entire surface of the first surface 11 and over a portion of the second surface 12. The resin paste 500 applied on the first surface 11 contacts the second layer 32. On second surface 12, a portion of graphite layer 41 is exposed from the metal layer 42. The resin paste 500 applied on the second surface 12 contacts the graphite layer 41 and the metal layer 42.

The application of the resin paste 500 on the second surface 12 may be intentional or may be the result of a portion of the resin paste 500 extending over the second surface 12 to more reliably apply the entire surface on the first surface 11. Thus, the boundary between the first surface 11 and the second surface 12 is not limited to a configuration covered by a resin paste 500 (protection layer 5) over the entire length. Only a portion of the boundary may be configured to be covered by a resin paste 500 (protection layer 5).

This embodiment can also inhibit damage to the solid electrolyte layer 3. Also according to this embodiment, a portion of the graphite layer 41 and a portion of the metal layer 42 are covered by a protective layer 5 (second part 52). As a result, it is possible to suppress the occurrence of peeling, cracking, etc. from the end of the graphite layer 41 and the end of the metal layer 42.

Also, as shown in FIG. 18, the thickness t1, which is the maximum thickness from the second side 12 to the surface of the second part 52 (protection layer 5), is thinner than the thickness t2, which is the maximum thickness from the second side 12 to the surface of the metal layer 42. This allows the second part 52 (protection layer 5) to protect the graphite layer 41 and the metal layer 42, while providing the second part 52 to avoid inadvertently increasing the size of the member including the porous sintered body 1, the dielectric layer 2, the solid electrolyte layer 3, the cathode layer 4 and the protective layer 5.

The methods of making solid electrolytic capacitors and solid electrolytic capacitors according to the present invention are not limited to the embodiments described above. The specific configuration of the solid electrolytic capacitor and the method of manufacturing the solid electrolytic capacitor according to the present invention can be modified in various ways.

### [Additional Note 1]

A porous sintered body having a first surface and comprising a valve metal;
An anode wire protruding from the first face and comprising a valve metal;
A dielectric layer formed on the porous sintered body;
A solid electrolyte layer formed on the dielectric layer;
A cathode layer formed on the solid electrolyte layer;
A solid electrolyte layer comprises a first layer formed on the dielectric layer and a second layer formed on the first layer;
A solid electrolytic capacitor comprising a protective layer covering at least a portion of the first surface through the first layer.

### [Additional Note 2]

The solid electrolytic capacitor of Appendix 1, wherein the protective layer is directly in contact with the first layer.

### [Additional Note 3]

The solid electrolytic capacitor according to Appendix 1, wherein the second layer is interposed between the first layer and the protective layer.

### [Additional Note 4]

Wherein the cathode layer comprises a graphite layer formed on the solid electrolyte layer and a metal layer formed on the graphite layer; the solid electrolytic capacitor of Appendix 3, wherein the protective layer is in contact with the graphite layer.

### [Additional Note 5]

The solid electrolytic capacitor according to Appendix 4, wherein the protective layer is in contact with the metal layer.

### [Additional Note 6]

The porous sintered body has a second surface separated from the anode wire and connected to the first surface; the cathode layer is formed on the second surface; the solid electrolytic capacitor according to Appendix 4 or 5, wherein the protective layer includes a first portion formed on the first surface and a second portion formed on the second surface.

### [Additional Note 7]

A solid electrolytic capacitor as described in Appendix 6, wherein a first thickness, which is a maximum thickness from the second surface to the surface of the second part, is thinner than a second thickness, which is the maximum thickness from the second surface to the surface of the metal layer.

### [Additional Note 8]

The solid electrolytic capacitor according to any one of Appendices 1 to 7, wherein the protective layer comprises at least one of a fluoropolymer, a silicone resin and an acrylic resin.

### [Additional Note 9]

The solid electrolytic capacitor according to any one of Appendices 1 to 8, wherein a third thickness from the first surface to the surface of the protective layer is thicker toward the anode wire.

### [Additional Note 10]

A method for manufacturing a solid electrolytic capacitor, comprising the step of: forming a porous sintered body having a first surface protruding an anode wire comprising a valve metal and comprising a valve metal; forming a dielectric layer on the porous sintered body, forming a solid electrolyte layer on the dielectric layer, forming a cathode layer on the solid electrolyte layer; the step of forming the solid electrolyte layer includes forming a first layer on the dielectric layer and forming a second layer on the first layer; and forming a protective layer covering at least a portion of the first surface after the step of forming the first layer.

### [Additional Note 11]

A method of manufacturing a solid electrolytic capacitor according to Appendix 10, wherein the step of forming the protective layer is performed prior to the step of forming the second layer.

### [Additional Note 12]

A method of manufacturing a solid electrolytic capacitor according to Appendix 10, wherein the step of forming the protective layer is performed after the step of forming the second layer and before the step of forming the cathode layer.

### [Additional Note 13]

A method for manufacturing a solid electrolytic capacitor according to Appendix 10, wherein the step of forming the cathode layer includes forming a graphite layer on the solid electrolyte layer; and forming a metal layer on the graphite layer, wherein the step of forming the protective layer is performed after the step of forming the graphite layer and before the step of forming the metal layer.

### [Additional Note 14]

A method of manufacturing a solid electrolytic capacitor according to appendix 10, wherein the step of forming the protective layer is performed after the step of forming the cathode layer.

### [Additional Note 15]

A method of manufacturing a solid electrolytic capacitor according to any one of Appendices 10 to 14, wherein the step of forming the first layer includes chemical polymerization process or electrolytic polymerization process.

### [Additional Note 16]

A method of manufacturing a solid electrolytic capacitor according to any one of Appendices 10 to 15, wherein the step of forming the second layer includes chemical polymerization process or electrolytic polymerization process.

### [Additional Note 17]

A method of manufacturing a solid electrolytic capacitor according to any one of Appendices 10 to 16, wherein the step of forming the protective layer is to apply a paste material to be the protective layer onto the first surface using a dispenser.

### [Additional Note 18]

A method of manufacturing a solid electrolytic capacitor according to any one of Appendices 10 to 17, wherein the protective layer comprises at least one of a fluoropolymer, a silicone resin and an acrylic resin.

### REFERENCE SIGNS LIST

A1, A2, A3, A4: solid electrolytic capacitors
1: Porous sintered body
2: Dielectric layer
3: Solid electrolyte layer
4: Cathode layer
5: Protective layer
6: Anode conduction member
7: Cathode conduction member
8: Sealing resin
10: Anode wire
11: First surface
12: Second surface
31: First layer
32: Second layer
41: Graphite layer
42: Metal layer
51: First part
52: Second part
61: Terminal part
62: Relay portion
79: Conductive bonding material
100: Intermediate
200: Chemical conversion solution
310, 320: Reaction solution
442: Graphite layer
500: Resin paste
Ds: Dispenser
t1, t2 and t3: Thickness

1. A porous sintered body having a first surface and comprising a valve metal;
An anode wire protruding from the first face and comprising a valve metal;
A dielectric layer formed on the porous sintered body;
A solid electrolyte layer formed on the dielectric layer;
A cathode layer formed on the solid electrolyte layer;
A solid electrolyte layer comprises a first layer formed on the dielectric layer and a second layer formed on the first layer;
A solid electrolytic capacitor comprising a protective layer covering at least a portion of the first surface through the first layer.

2. A solid electrolytic capacitor of claim 1, wherein the protective layer is directly in contact with the first layer.

3. A solid electrolytic capacitor of claim 1, wherein the second layer is interposed between the first layer and the protective layer.

4. A solid electrolytic capacitor according to claim 3, wherein the cathode layer comprises a graphite layer formed on the solid electrolyte layer and a metal layer formed on the graphite layer, and the protective layer is in contact with the graphite layer.

5. A solid electrolytic capacitor of claim 4, wherein the protective layer is in contact with said metal layer.

6. A solid electrolytic capacitor according to claim 4, wherein the porous sintered body has a second surface separated from the anode wire and connected to the first surface; the cathode layer is formed on the second surface; the cathode layer is formed on the second surface, and the protective layer comprises a first portion formed on the first surface and a second portion formed on the second surface.

7. A solid electrolytic capacitor as described in claim 6, wherein a first thickness, which is a maximum thickness from the second surface to the surface of the second part, is thinner than a second thickness, which is the maximum thickness from the second surface to the surface of the metal layer.

8. A solid electrolytic capacitor of claim 1, wherein the protective layer comprises at least one of a fluororesin, a silicone resin and an acrylic resin.

9. A solid electrolytic capacitor according to claim 1, wherein a third thickness from the first surface to the surface of the protective layer is thicker toward the anode wire.

10. A method for manufacturing a solid electrolytic capacitor, comprising the step of: forming a porous sintered body having a first surface protruding an anode wire comprising a valve metal and comprising a valve metal; forming a dielectric layer on the porous sintered body; forming a solid electrolyte layer on the dielectric layer; forming a cathode layer on the solid electrolyte layer; the step of forming the solid electrolyte layer includes forming a first layer on the dielectric layer and forming a second layer on the first layer; and forming a protective layer covering at least a portion of the first surface after the step of forming the first layer.

11. A method of manufacturing a solid electrolytic capacitor according to claim 10, wherein the step of forming the protective layer is performed before the step of forming the second layer.

12. A method of manufacturing a solid electrolytic capacitor according to claim 10, wherein after the step of forming the second layer, the step of forming the protective layer is performed prior to the step of forming the cathode layer.

13. A method for manufacturing a solid electrolytic capacitor according to claim 10, wherein the step of forming the cathode layer includes forming a graphite layer on the solid electrolyte layer; and performing the step of forming the protective layer after the step of forming the graphite layer and before the step of forming the metal layer.

14. A method of manufacturing a solid electrolytic capacitor according to claim 10, wherein the step of forming the protective layer is followed by forming the cathode layer.

15. A method of manufacturing a solid electrolytic capacitor according to claim 10, wherein the step of forming the first layer comprises a chemical or electrolytic polymerization process.

16. A method of manufacturing a solid electrolytic capacitor according to claim 10, wherein the step of forming the second layer comprises a chemical or electrolytic polymerization process.

17. A method of manufacturing a solid electrolytic capacitor according to claim 10, wherein the step of forming the protective layer applies a paste material to the protective layer on the first surface with a dispenser.

18. A method of manufacturing a solid electrolytic capacitor according to claim 10, wherein the protective layer comprises at least one of a fluoropolymer, a silicone resin, and an acrylic resin.
